(19) United States
(12) Patent Application Publication
(10) Pub. No.: US 2019/0069675 A1
(43) Pub. Date: Mar. 7, 2019

(54) Storage Rack Labeling Receptacle

(71) Applicant: Robert A. Johannessen, Quincy, IL (US)

(72) Inventor: Robert A. Johannessen, Quincy, IL (US)

(21) Appl. No.: 15/695,879

(22) Filed: Sep. 5, 2017

(51) Int. Cl. A47B 96/14; H01F 1/04; B65G 1/02; G09F 3/08

(52) U.S. Cl. CPC A47B 96/14; G09F 3/08; B65G 1/02; H01F 1/04

(57) ABSTRACT

An ID placard receptacle formed in a beam of a pallet storage rack structure has dimensions slightly larger than a magnetic-backed a pallet rack label placard used to identify pallets stored within the structure. The receptacle has protruding edges that bound the pallet rack label placard, helping to prevent damage or inadvertent removal of the placard. The protruding edges are formed by pressing the metal of the beam one way, and the receptacle is formed by pressing the metal of the beam the other way. Pressing the beam's metal rather than stamping it tends to strengthen the beam rather than weaken it.

### BACKGROUND

### Technical Field

Various embodiments of the present invention relate to warehousing logistic systems, and more specifically, to apparatus and methods of labeling storage racks.

### Description of Related Art

Nearly every product for sale in America, and the components making up those products, spend time in several warehouses before reaching the end consumer. Warehousing operations are crucial at all junctures of commerce from the time the raw materials and components are gathered and assembled, all the way through delivery to the consumer. Components and raw materials are sorted, packaged and stored during one or more stages of assembly and manufacturing, during wholesale distribution, during retail distribution, and during transportation between all the various phases of manufacturing and marketing.

Quite often pallets are used during warehousing operations to store, distribute and transport raw materials, component assemblies and finished products as they make their way from the manufacturer into the stream of commerce. Pallets provide uniformity for product handling operations. Boxes, barrels, containers and even the various items themselves are stacked or fastened onto pallets. Fork lift drivers efficiently convey the loaded pallets to pallet storage racks within warehouses and manufacturing storage facilities. Keeping track of the many thousands of pallets that pass through a typical warehouse each week requires an extensive record keeping and logistics system.

Accurate labeling and record keeping are crucial to maintaining an efficient warehousing operation. Either the pallets themselves or the items stowed on the pallets must be labeled. The pallet storage racks must also be labeled in order to accurately map the location of individual pallets. Labeling of the pallet storage racks is especially important for storage areas containing stacked pallets that are not immediately accessible. Some pallet storage rack structures feature pallets of goods that are stacked many rows high, and many columns deep within the pallet rack structure. For example, a push back pallet rack structure uses a cart and rail system to send a pallet of goods deep into the rack structure. It can be difficult to track individual pallets due to warehouses constantly being reconfigured as varying quantities of different goods are stored and moved. Individual pallets are similarly inaccessible in drive-in pallet rack systems and two-deep reach systems. Thus, the racks containing the pallets must be labeled as well in order to accurately map the location of each individual pallet. If the racks aren't labeled, or if the rack label is damaged or lost, a pallet can't be logged in at the time it is stored within the stack. A pallet that isn't logged in is likely to be lost among the thousands of pallets contained in a large pallet rack system.

Given the inaccessibility of pallets buried within a massive pallet rack structure, the need for accurate labels on the rack structure that are easily updated is readily apparent.

### BRIEF SUMMARY

The present inventor recognized the logistical problems that are caused by damaged pallet rack labels, and the need for a pallet rack labeling system that is easy to reconfigure, yet resistant to being accidentally removed or damaged. The various embodiments disclosed herein achieve these goals, and others which will become readily apparent.

### BRIEF DESCRIPTION OF THE DRAWINGS

The accompanying drawings, which are incorporated in and constitute part of the specification, illustrate various embodiments of the invention. Together with the general description, the drawings serve to explain the principles of the invention. In the drawings:

FIG. 1 depicts an oblique cutaway view of a push-back pallet storage rack with pallet rack labels according to various embodiments disclosed herein.

FIG. 2 depicts a cutaway portion of a beam from a pallet storage rack configured to receive pallet rack labels according to various embodiments disclosed herein.

FIG. 3 depicts a cross-section of the beam illustrated in FIG. 2 taken along the line A-A′.

### DETAILED DESCRIPTION

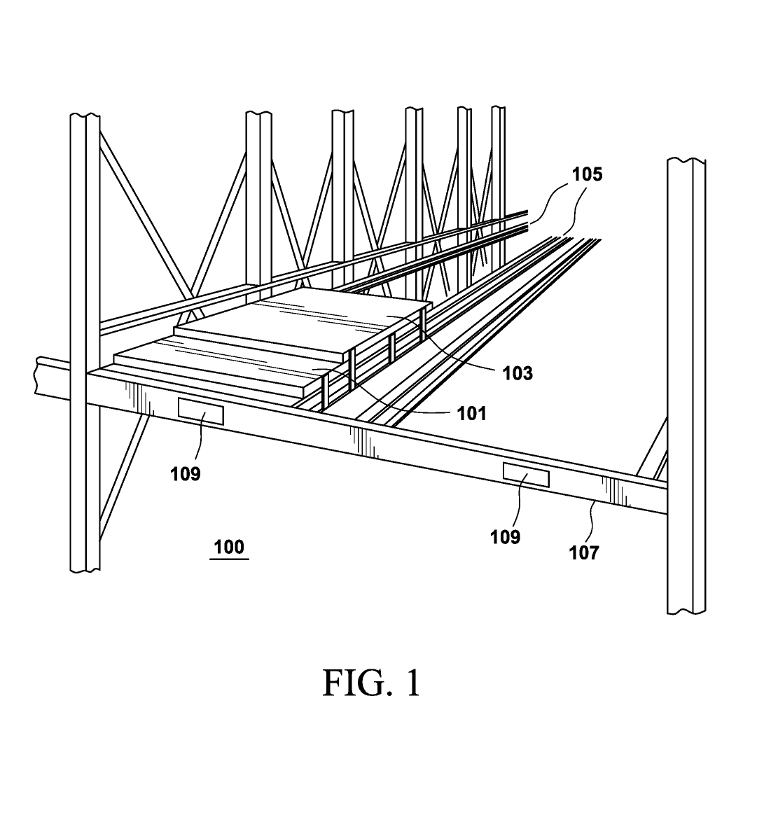

FIG. 1 depicts an oblique cutaway view of a push-back pallet storage rack system 100 according to various embodiments disclosed herein. Pallets are placed on wheeled carts 101 and 103 that ride back into the rack system 100 on rails 105. The figure only shows one set of rails for the sake of illustration. A typical push-back pallet storage rack system has many sets of rails side by side, and on several vertical levels. This allows stacks of pallets to be stored several columns deep—thus saving storage room by organizing the pallets into a high density structure.

Typically, the rails 105 are configured at a slight pitch that allows the force of gravity to gradually roll the wheeled carts 101-103 towards the front of the rack system 100, in position for a forklift operator to remove the front-most pallet. A stop provided at the front of the rails prevents the wheeled carts from falling off the front of the storage rack into the aisle.

When the push-back pallet storage rack of FIG. 1 is full, the back-most pallet is buried several pallets deep and thus cannot be easily reached for auditing or discovering what is contained on the pallet. This is true of other types of pallet storage systems as well, including for example, two-deep reach system. Since the pallets may be buried deep within a large pallet rack structure it is important that accurate records be kept in order to map and track the location of individual pallets of goods and materials. FIG. 1 illustrates pallet rack labels 109 on a beam 107 of the pallet rack system 100.

A major problem in trying to keep accurate record is that the conventional labels on pallet racks tend to become damaged or lost over time. Adhesive backed labels can be used. But they are difficult to remove and replace, and become worn or scraped off over time. It's only takes one scrape by a fork lift to damage a label beyond recognition. Magnetic backed labels are favored because of their ease of removal and replacement. The pallet racks are made from steel or iron beams and members. Magnetic backed labels stick to the pallet rack beams, and are easily removed to be replaced or altered without leaving an adhesive residue. The problem is, magnetic backed labels can inadvertently be damaged or removed by an accidental scrape from a fork lift. A magnetic label has no value for record keeping if it's lying on the floor. Various embodiments of the present invention provide a receptacle on a beam in the pallet rack structure that aids in keeping the magnetic labels safe and damage free.

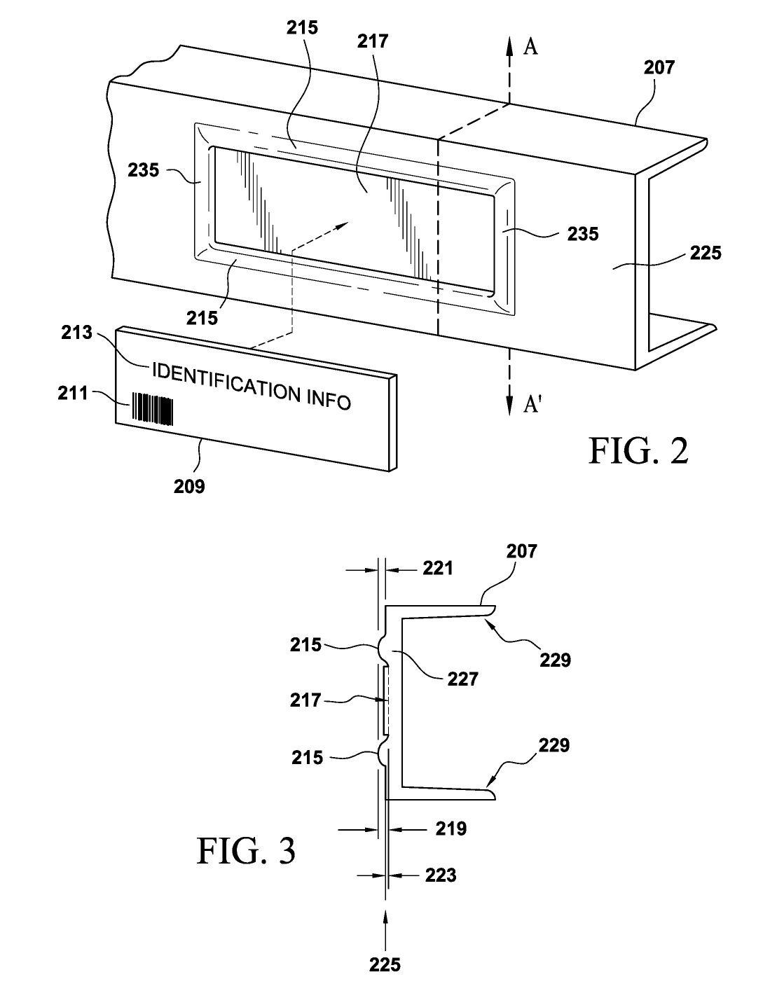

FIG. 2 depicts a cutaway portion of a beam 207 from a pallet storage rack configured to receive a pallet rack identification label placard 209 (or ID placard 209) according to various embodiments disclosed herein. The ID placard 209 typically has alphanumeric text, symbols and/or bar code written on it to store information about the content of the pallet storage rack on which it is placed. The beam 207 is typically located on the front end of a pallet rack structure, such as beam 107 of the pallet rack system 100 illustrated in FIG. 1. The beam 207 depicted in FIGS. 2-3 is a 4 inch structural channel beam with a “C” cross-section. However, other types of beams and other dimensions may be used to implement the various embodiments. The identification label 209 depicted in FIG. 2 has a magnetic backing that attracts to iron and various other ferromagnetic metals, thus magnetically adhering the label to the beam 207.

The identification label 209 fits within a recessed portion 217 of the beam 207. In various embodiments the surface of the recessed portion 217 is relatively flat to promote magnetic adhesion by the label 209—approximately as flat as the surface of the beam itself. The flat surface of the surface of the recessed portion 217 is called the floor of the surface of the recessed portion 217. The beam 207 has lengthwise protruding portions 215 outside and adjacent the recessed portion 217. The lengthwise protruding portions 215 run above and below the respective top and bottom edges of a pallet rack label placard 209 placed within the recessed portion 217. The beam 207 also has side protruding portions 235 that run along the side edges of a pallet rack label placard 209 placed within the recessed portion 217. The lengthwise protruding portions 215 depicted in FIG. 2 are oriented orthogonal to the side protruding portions 235. In various embodiments the lengthwise protruding portions 215 and side protruding portions 235 may be the same height. In other embodiments the lengthwise protruding portions 215 may be either taller or shorter than the side protruding portions 235.

The protruding portions 215 and 235 are considered “adjacent” the recessed portion 217 so long as they are within one inch of the edge of the recessed portion 217. The recessed portion 217 taken together with the lengthwise protruding portions 215 and/or side protruding portions 235 may be referred to as an ID placard receptacle. In the embodiment depicted in FIG. 2 the protruding portions 215 and 235 entirely surround the recessed portion 217. In other embodiments the protruding portions 215 and 235 do not entirely surround the recessed portion 217 of the ID placard receptacle. For example, in some embodiments the protruding portions 215 may only be provided lengthwise along the top and bottom of recessed portion 217 without the side protruding portions 235. In other embodiments the protruding portions 215 and/or 235 may be intermittent or have gap(s), and as such, are provided along only a portion of the top and bottom of recessed portion 217, and/or along a portion of the sides. In yet other embodiments only the side protruding portions 235 are provided without the lengthwise protruding portions 215.

FIG. 3 depicts a cross-section of the beam 207 taken along the line A-A′ in FIG. 2. The vertical component of beam 207 depicted in the figure is a web 227. The outer surface of web 227 is the flat surface of face 225. The beam 207 has top and bottom flanges 227 extending from web 227. As shown in FIG. 3 the recessed portion 217 of the ID placard receptacle is below the level of the beam's face surface 225 by a floor depth 223. As depicted in FIG. 3 a top surface of the protruding portions 215 and 235 extends above level of the beam's face surface 225 by a height 221. The dimension describing how deep the recessed portion 217 is below the surface of the beam's face is referred to as “floor depth” as if the beam is lying flat with the recessed portion 217 sunk down into beam and the protruding portions 215 and 235 are sticking up. For the sake of simplicity the term “depth” may used to describe the recessed portion 217 regardless of the orientation of the beam at a particular time since it is the depth relative to the beam's face surface 225. That is, “depth” as used herein does not imply and up and down orientation relative to the earth. Similarly, the dimension defining the protruding portion 215 may be referred to as “height” regardless of the orientation of the beam at a particular time.

The height of the protruding portions 215 and 235 is measured by a top edge of the portions 215 and 235. However, in some implementations the top edge may not be perfectly uniform in height at all points. In such instances the average top edge height is used to measure the height 221 of protruding portions 215 and 235 for those portions of the ID placard receptacle where there are protruding portions. In different implementations the protruding portions 215 and 235 are raised to various heights above the level of the beam's face surface 225. A typical height 221 for the protruding portions 215 and/or 235 is ⅛th inch+/−20% above the beam's face surface 225. Other implementations are characterized by other heights for one or the other of protruding portions 215 and or 235. For example, either the protruding portion 215 or the protruding portion 235 may be raised above the beam's face surface 225 by 1/16th inch, ⅛th inch, 3/16th inch, ¼th inch or any amount up to ¾ inch (by 1/32nd inch increments)+/−20% of each height.

Similar to the height 221 of the protruding portions 215 and 235, the depth 223 of the recessed portion 217 may be implemented in different amounts. A typical depth 223 for the recessed portion 217 is ⅛th inch+/−20% below the beam's face surface 225. In other implementations the depth 223 for the recessed portion 217 may be any depth from 1/16th inch+/−20% to as much as ¾ in +/−20% by 1/32nd inch increments. As such, a typical value for the depth of the surface of recess 217 below the height of the protruding portion 215 is ¼th inch+/−40% (or +/−30%; or +/−20%; or +/−10%). In another embodiment the depth of the surface of recess 217 below the height of the protruding portion 215 is ⅜th inch+/−40% (or +/−30%; or +/−20%; or +/−10%).

The receptacle depth 219 is defined as the depth of the surface of recess 217 below the height of the protruding portions 215 and/or 235. (In embodiments where the protruding portions 215 and 235 are of different heights, the receptacle depth 219 is defined as the depth from the highest of the two.) Generally, the thickness of the pallet rack label placard to be held should preferably be less than the receptacle depth 219. For example, if the receptacle depth 219 is ¼ inch then it is generally preferable to use a pallet rack label placard having a thickness of less than ¼ inch. This reduces the chances of the placard being scraped off or damaged by a fork lift.

Generally, the ID placard receptacle 217 is slightly larger than the pallet rack label placard 209 anticipated to be used with it. For example, in some embodiments the height and width dimensions of the ID placard receptacle 217 are each ¼ inch longer than the dimensions of the pallet rack label placard 209 to be used with it. A common size of pallet rack label placard 209 in use is 12 inches wide and 2 inches high, as viewed from the front of beam 225. For such a 12×2 inch pallet rack label placard 209, an ID placard receptacle 217 with dimensions of 12¼ inch by 2¼ inch would be appropriate. Various embodiments of the ID placard receptacle 217 disclosed herein may be used with many other sizes and shapes of the pallet rack label placard 209. The shape of the pallet rack label placard 209 depicted in FIG. 2 is rectangular. Since rectangular pallet rack label placards 209 are to be used in this particular implementation, the ID placard receptacle is rectangular as well. Various other embodiments feature different shaped ID placard receptacles, e.g., square, round, oval, triangular, flattened oval, or other like shapes as are known by those of ordinary skill in the art. Strictly speaking, the shape of the ID placard receptacle depicted in FIG. 2 is rectangular with rounded corners. The rounded corners are a result of the pressing process used in making the ID placard receptacle. For the sake of simplicity, this shape—rectangular with rounded corners—shall hereinafter simply be referred to as rectangular since it would be difficult to make an ID placard receptacle in a metal beam having perfectly square corners.

Various embodiments are made by pressing a pallet rack beam into the desired shape and depth for an ID placard receptacle to receive a pallet rack label placard 209. This may be done with a hydraulic press having sufficient power to press the beam one way to deform the metal in the direction of the protruding portions 215 and 235, and then the other way to press the recess 217 to the desired depth. In other implementations a rigid template is used and the two matching dies of the press form the ID placard receptacle to shape between the two dies, rather than pressing the beam one way and then the other. In some implementations the protruding portion may be formed from a weld bead added to the beam instead of being pressed and formed from the metal of the beam itself.

In some implementations the shape of the ID placard receptacle may be stamped as opposed to being pressed. Stamping is a more rapid process that requires a more violent, higher speed blow. Pressing is a process in which the metal is slowly pressed into shape. For the sake of distinguishing the two herein, the process of “stamping” shall refer to a process in which a single downward blow places downward force for less than a half second on the beam face being formed. Quite often the downward force is applied to the beam for less than a half second (e.g., ¼ second or less) in the process of stamping. The term “pressing” shall refer herein to the process in which a downward force takes place over a time period of a half second or more. Quite often the downward force is applied to the beam for considerably more than a half second (e.g., 15 seconds or more) in the process of pressing. One aspect of distinguishing between stamping and pressing is that, depending upon the shape being pressed into the metal, the process of pressing may strengthen the beam. By contrast, stamping the same shape into a beam may not necessarily strengthen the beam—and may in fact weaken the beam under certain conditions.

For the sake of illustration the figures depict an ID placard receptacle being formed using a structural channel beam—that is, a beam with a “C” shaped cross-section. Various other embodiments use other types of beams and metal braces. For example, in some embodiments the ID placard receptacle could be formed in straight walled structural tubing, on metal plates, in I-beams, on angle iron, or other like types of metal structural components. This description has discussed embodiments of the ID placard receptacle being formed in a ferromagnetic metal such as steel or iron for use with a magnetic-backed pallet rack label placard. However, some embodiments may be formed from non-ferromagnetic metals for use with adhesive backed pallet rack label placards. Such non-ferromagnetic metals include aluminum, copper, titanium, various alloys and other types of non-ferromagnetic metals known to those of ordinary skill in the art. Some embodiments may also be formed from non-metallic beams, or portions of beam, that are non-magnetic for use with adhesive backed pallet rack label placards. Such non-magnetic materials may include fiber glass, synthetic composite materials, concrete, wood or other like types of non-magnetic materials as are known by those of ordinary skill in the art.

The various embodiments have been described in terms of a pallet rack label placard with either a magnetic backing or an adhesive that can be removably affixed to the ID placard receptacle. Some implementations use a hook and loop Velcro™ patch to removably affix the pallet rack label placard to the ID placard receptacle. Such a Velcro™ patch is considered herein to be adhesive backed since both parts of the Velcro™ patch affix to the parts with adhesive.

The descriptions contained in this disclosure are written in terms of an ID placard receptacle for use with a magnetic-backed pallet rack label placard. However, in at least some implementations an adhesive backed pallet rack label placard could be used with the various embodiments. The ID placard 209 has been described above as having alphanumeric text, symbols and/or bar code written on it to store information about the content of the pallet storage rack on which it is placed. In some embodiments, a pallet rack label placard having an electronic assembly (e.g., an RFID or electronic storage device) is used with the various ID placard receptacle embodiments disclosed herein. Further, the various embodiments may be implemented with other types of rack structures aside from pallet rack structures including any type of rack structure with an exposed beam towards the front on which an ID placard receptacle could be placed.

The terminology used herein is for the purpose of describing particular embodiments only and is not intended to be limiting of the invention. As used in the specification and claims the term “substantially” means plus or minus (+/−) ten percent. For example, “substantially one inch” means “one inch plus or minus ten percent.” As used herein, the singular forms “a”, “an” and “the” are intended to include the plural forms as well, unless the context clearly indicates otherwise. It will be further understood that the terms “comprises,” “comprising,” “includes,” and/or “including” used in this specification specify the presence of stated features, integers, steps, operations, elements, and/or components, but do not preclude the presence or addition of one or more other features, integers, steps, operations, elements, components, and/or groups thereof. The term “plurality”, as used herein and in the claims, means two or more of a named element. It should not, however, be interpreted to necessarily refer to every instance of the named element in the entire device. Particularly, if there is a reference to “each” element of a “plurality” of elements. There may be additional elements in the entire device that are not be included in the “plurality” and are not, therefore, referred to by “each.”

The corresponding structures, materials, acts, and equivalents of all means or step plus function elements, if any, in the claims below are intended to include any structure, material, or act for performing the function in combination with other claimed elements as specifically claimed. The disclosure of the various embodiments have been presented for purposes of illustration and description, and is not intended to be exhaustive in the form disclosed. Many modifications and variations will be apparent to those of ordinary skill in the art without departing from the scope and gist of the invention. The various embodiments included herein were chosen and described in order to best explain the principles of the invention and the practical application, and to enable others of ordinary skill in the art to understand the invention for various embodiments with various modifications as are suited to the particular use contemplated. The description of the various embodiments provided above is illustrative in nature inasmuch as it is not intended to limit the invention, its application, or uses. Thus, variations that do not depart from the intents or purposes of the invention are encompassed by the various embodiments of the present invention. Such variations are not to be regarded as a departure from the intended scope of the present invention.

What is claimed:

1. An ID placard receptacle configured to receive a rack beam label placard having a placard thickness, the ID placard receptacle comprising:
a beam of a storage rack structure having a flat surface;
a recessed portion of said beam disposed to receive the rack beam label placard, the recessed portion having a receptacle floor at a floor depth below the flat surface; and
a protruding portion of said beam outside and adjacent to the recessed portion, a top edge of the protruding portion being a given height above the flat surface;
wherein a receptacle depth is defined as a difference between the given height of the protruding portion and the floor depth of the receptacle floor, the receptacle depth being greater than the placard thickness.

2. The ID placard receptacle of claim 1, wherein the receptacle depth is at least ⅛ inch;
wherein the beam is a ferromagnetic metal beam; and
wherein the rack beam label placard has a magnetic back.

3. The ID placard receptacle of claim 2, wherein the protruding portion comprises:
at least two lengthwise protruding portions.

4. The ID placard receptacle of claim 3, wherein the protruding portion comprises:
at least two side protruding portions oriented orthogonal to the at least two lengthwise protruding portions.

5. The ID placard receptacle of claim 2, wherein the placard thickness is at least 1/16 inch and the wherein the receptacle depth is substantially 3/16 inch.

6. The ID placard receptacle of claim 2, wherein the protruding portion extends in a first direction from said beam; and
wherein the protruding portion of said beam is formed from the metal of the beam.

7. The ID placard receptacle of claim 6, wherein the protruding portion of said beam is formed from the metal of the beam pressed in the first direction.

8. The ID placard receptacle of claim 7, wherein the receptacle floor is formed from the metal of the beam pressed in a second direction opposite the first direction.

9. The ID placard receptacle of claim 1, wherein the beam is a structural channel beam.

10. A method of making an ID placard receptacle configured to receive a rack beam label placard having a placard thickness, the method comprising:
obtaining a beam of a storage rack structure, the beam having a web with a flat surface oriented orthogonal to a first direction, the beam comprising at least two flanges extending in a second direction from said web, the second direction being opposite the first direction;
pressing the beam to deform metal of the beam in the first direction;
pressing the beam to deform the metal of the beam in the second direction to form a recessed portion of said beam disposed to receive the rack beam label placard;
forming a receptacle floor parallel within the recessed portion, the receptacle floor being parallel to a plane of the flat surface, and being at a floor depth below the flat surface;
forming a protruding portion of said beam outside and adjacent to the recessed portion, a top edge of the protruding portion being a given height above the flat surface;
wherein a receptacle depth is defined as a difference between the given height of the protruding portion and the floor depth of the receptacle floor, the receptacle depth being greater than the placard thickness.

11. The method of claim 10, wherein the protruding portion of said beam is formed from the metal of the beam being pressed in the first direction; and
wherein the receptacle floor is formed from the metal of the beam being pressed in the second direction.

12. The method of claim 11, wherein the beam is a ferromagnetic metal beam; and
wherein the rack beam label placard has a magnetic back.

13. The method of claim 12, wherein the protruding portion comprises:
at least two lengthwise protruding portions; and
at least two side protruding portions oriented orthogonal to the at least two lengthwise protruding portions.

14. The method of claim 12, wherein the placard thickness is at least 1/16 inch and the wherein the receptacle depth is at least 3/16 inch.

15. The method of claim 12, wherein the beam is a structural channel beam.
